(19) United States
(12) Patent Application Publication
(10) Pub. No.: US 2025/0139305 A1
(43) Pub. Date: May 1, 2025

(54) TECHNIQUES TO IMPLEMENT MUTUAL AUTHENTICATION FOR CONFIDENTIAL COMPUTING

(71) Applicant: Intel Corporation, Santa Clara, CA (US)

(72) Inventors: Ravi SAHITA, Portland, OR (US); Jiewen YAO, Shanghai (CN)

(21) Appl. No.: 18/834,417

(22) PCT Filed: Mar. 31, 2022
(86) PCT No.: PCT/CN2022/084243

§ 371 Date: Jul. 30, 2024

(51) Int. Cl. G06F 21/85; G06F 21/44; G06F 21/60

(52) U.S. Cl. CPC G06F 21/85; G06F 21/44; G06F 21/606

(57) ABSTRACT

Examples include techniques to implement mutual authentication for confidential computing. Examples are described of implementing mutual authentication for confidential computing that includes use of local attestation.

### TECHNICAL FIELD

Examples described herein are generally related to techniques associated with implementing mutual authentication for confidential computing that includes use of local attestation.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

FIG. 1 illustrates an example first system.

FIG. 2 illustrates an example second system.

FIG. 3 illustrates an example first scheme.

FIG. 4 illustrates an example second scheme.

FIG. 5 illustrates an example logic flow.

FIG. 6 illustrates an example storage medium.

FIGS. 7A and 7B illustrate block diagrams of core architectures.

FIG. 8 illustrates an example processor.

FIG. 9 illustrates a first example computer architecture.

FIG. 10 illustrates a second example computer architecture.

FIG. 11 illustrates an example software instruction converter.

### DETAILED DESCRIPTION

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM) (e.g., an Intel® Optane™ memory), for example, accessible according to a Peripheral Component Interconnect Express (PCIe) specification such the PCIe Base Specification Revision 6.0, Ver. 1.0, published in January 2022 (“the PCIe specification”).

In some examples of computing, a virtual machine (VM) (e.g., guest) is an emulation of a computer system. For these examples, VMs may be based on a specific computer architecture and provide the functionality of an underlying physical computer system. VM implementations may involve specialized hardware, firmware, software, or a combination. In certain examples, a virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM/hypervisor may manage the backend operation of these VMs by allocating the necessary computing, memory, storage, and other input/output (I/O) resources, such as, but not limited to, an input/output memory management unit (I/OMMU). The VMM may provide a centralized interface for managing the entire operation, status, and availability of VMs that are installed over a single host machine or spread across different and interconnected hosts.

However, it may be desirable to maintain security (e.g., confidentiality) of information for a virtual machine from the VMM and/or other virtual machine(s). Certain processors (e.g., a system-on-a-chip (SoC) including a processor) utilize their hardware to isolate virtual machines, for example, with each referred to as a “trust domain”. Certain processors support an instruction set architecture (ISA) (e.g., ISA extension) to implement trust domains. For example, Intel® trust domain extensions (Intel® TDX) that utilize architectural elements to deploy hardware-isolated VMs are referred to as trust domains (TDs).

According to some examples, a hardware processor and its ISA (e.g., a trust domain manager thereof) isolates TD VMs from the VMM/hypervisor and/or other non-TD software (e.g., on the host platform). For these examples, a hardware processor and its ISA (e.g., a trust domain manager thereof) implement TDs to enhance confidential computing by helping protect the TDs from a broad range of software attacks and reducing the TD trusted computing base (TCB). In certain examples, a hardware processor and its ISA (e.g., a trust domain manager thereof) enhances a cloud tenant's control of data security and protection. In some examples, a hardware processor and its ISA (e.g., a trust domain manager thereof) implement TDs (e.g., trusted VMs) to enhance a cloud-service provider's (CSP) ability to provide managed cloud services without exposing tenant data to adversaries.

In some examples, a hardware processor and its ISA (e.g., a trust domain manager thereof) also support device I/O. For example, with an ISA (e.g., Intel® TDX 2.0) supporting trust domain extensions (TDX) with device I/O (e.g., TDX-IO). For these examples, a hardware processor and its ISA (e.g., a trust domain manager thereof) that support device I/O (e.g., TDX-IO) enable the use (e.g., assignment) of a physical function (PF) and/or virtual function (VF) of a device to (e.g., only) a specific TD.

According to some examples, an I/O device is an accelerator. One or more types of accelerators may be utilized. For example, a first type of accelerator may be accelerator circuit, e.g., an In-Memory Analytics accelerator (IAX). A second type of accelerator supports a set of transformation operations on memory, e.g., a data streaming accelerator (DSA). For example, the accelerator is to generate and test cyclic redundancy check (CRC) checksum or Data Integrity Field (DIF) to support storage and networking applications and/or for memory compare and delta generate/merge to support VM migration, VM fast check-pointing, and software managed memory deduplication usages. A third type of accelerator supports security, authentication, and compression operations (e.g., cryptographic acceleration and compression operations), e.g., a QuickAssist Technology (QAT) accelerator.

In some examples, in order to establish a trust relationship between a device and a TD, certain TDX-IO architectures require the TD and/or a trust domain manager (e.g., circuit and/or code) (e.g., Trusted Execution Environment (TEE) security manager (TSM)) to create a secure communication session between the device and the trust domain manger (e.g., for the trust domain manger to allow a particular TD to use the device or a subset of function(s) of the device). For these examples, in order to establish the trust relationship between a device and a TD, certain TDX-IO architectures require the TD and/or a trust domain manager (e.g., circuit and/or code) (e.g., TSM) to use various specifications to include, but not limited to, a Distributed Management Task Force (DMTF) Secure Protocol and Data Model (SPDM) specification such as the SPDM specification, DSP0274, Ver. 1.0.1, published in March 2021 by the Platform Management Components Intercommunication (PMCI) working group of the DMTF (hereinafter “the SPDM specification”) to authenticate the device (e.g., and collect device measurement). The TD and/or trust domain manager may also use various specifications to include, but not limited to, specifications published by the Peripheral Component Interconnect Special Interest Group (PCI-SIG) and/or other specifications or standards that describe use of a Trusted Device Interface Security Protocol (TDISP) to communicate with a device security manager (DSM) to manage the device's virtual function(s).

According to some examples, a SPDM messaging protocol used according to the SPDM specification defines a request-response messaging model between two endpoints to perform a message exchange, for example, where each SPDM request message shall be responded to with an SPDM response message. For these examples, an endpoint's (e.g., device's) “measurement” describes the process of calculating a cryptographic hash value of a piece of firmware/software or configuration data and tying the cryptographic hash value with the endpoint's identity through a use of digital signatures. This allows an authentication initiator to establish that the identity and measurement of the firmware/software and/or a configuration currently running on the endpoint.

In some examples, to help enforce security policies for TDs, a new mode of a processor called Secure-Arbitration Mode (SEAM) is introduced to host (e.g., manufacturer provided) a digitally signed, but not encrypted, security-services module. For example, a trust domain manager (TDM) may be hosted in a reserved, memory space identified by a SEAM-range register (SEAMRR). For this example, the processor may only allow access to a SEAM-memory range by software executing inside the SEAM-memory range, and all other software accesses and direct-memory access (DMA) from devices to this SEAM-memory range are aborted. In some examples, a SEAM module does not have any memory-access privileges to other protected, memory regions in a compute/host platform, including the System-Management Mode (SMM) memory or (e.g., Intel® Software Guard Extensions (SGX)) protected memory.

Certain standards (e.g., specifications or standards that describe use of TDISP message protocols) introduce a TSM concept, but do not describe how to implement the TSM in a confidential computing environment, e.g., an environment implementing TDX-IO. One solution is to allow the (e.g., SPDM) communication work (e.g., to establish a secure communication session) to be performed by a secure startup service module (S3M) of the SoC (e.g., processor). In certain examples, a secure startup service circuit includes SPDM capability and stack/device attestation capability, e.g., to support TDX-IO uses and other (e.g., non TDX-IO) uses.

It should be understood that the functionality described in this disclosure may be added to other confidential computing technology as a computing solution for I/O devices. For example, AMD® Secure Encrypted Virtualization (e.g., SEV/SEV-ES/SEV-SNP) may use a certain component (e.g., a Platform Security Processor (PSP)) thereof to implement a TSM, for example, a whole TSM including two parts: (i) a trust domain manager that enforces the TEE isolation, and (ii) the PSP that handles communications with the device security manager (DSM). For example, ARM® Realm Management Extension (RME) may use a certain component (e.g., one ARM® core of a plurality of ARM® cores) thereof to implement a TSM, for example, a whole TSM including two parts: (i) a trust domain manager that enforces the TEE isolation, and (ii) the ARM® core that handles communications with the device security manager (DSM).

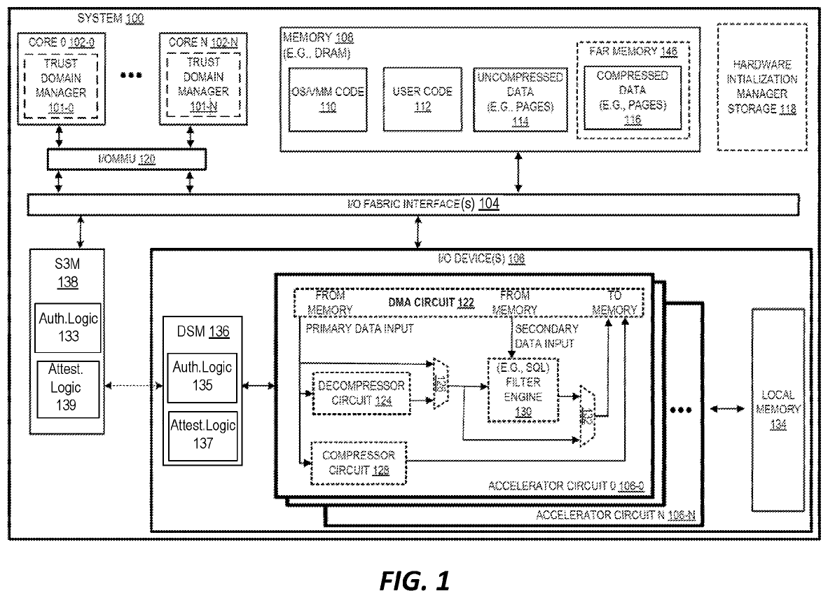

FIG. 1 illustrates an example system 100. System 100 may be a computer system to implement techniques associated with TDX-IO on a single host computer system (e.g., a host server). According to some examples, system 100 may have all the elements or components shown in FIG. 1 co-located on a same physical machine (e.g., same host server or platform). In other words, the components of system 100 shown in FIG. 1 are located locally (e.g., same host server) as compared to at least some other components of system 100 (e.g., an I/O device from among I/O device(s) 106) being remotely located. For these examples, as shown in FIG. 1, system 100 includes a plurality of cores 102-0 to 102-N (e.g., where Nis any positive integer greater than one, although single core examples may also be utilized) having a trust domain manager 101-0 to 101-N, a memory 108 (e.g., a system memory separate from a processor and/or core memory), an input/output memory management unit (I/OMMU) 120 (e.g., circuit), one or more input/output (I/O) device(s) 106, and a secure startup service module (S3M) 138.

According to some examples, I/O device(s) 106 includes one or more accelerators (e.g., accelerator circuits 106-0 to 106-N (e.g., where Nis any positive integer greater than one, although single accelerator circuit examples may also be utilized)).

Although the example shown in FIG. 1 of I/O device(s) 106 indicates an accelerator circuit, it should be understood that other types of devices (e.g., non-accelerator devices) are contemplated by this disclosure (e.g., storage or memory devices). In the depicted example, an (e.g., each) accelerator circuit 106-0 to 106-N of I/O device(s) 106 includes a decompressor circuit 124 to perform decompression operations, a compressor circuit 128 to perform compression operations, and a direct memory access (DMA) circuit 122, e.g., to connect to memory 108 and/or internal memory (e.g., cache) of a core. In one example, compressor circuit 128 is (e.g., dynamically) shared by two or more accelerator circuits 106-0 to 106-N. In some examples, data for a job that is assigned to a particular accelerator circuit (e.g., accelerator circuit 106-0) is streamed in by DMA circuit 122, for example, as primary and/or secondary input. Multiplexers 126 and 132 may be utilized to route data for a particular operation. Optionally, a (e.g., Structured Query Language (SQL)) filter engine 130 may be included, for example, to perform a filtering query (e.g., for a search term input on the secondary data input) on input data, e.g., on decompressed data output from decompressor circuit 124. I/O device(s) 106 may include a local memory 134, e.g., shared by a plurality of accelerator circuits 106-0 to 106-N. In some examples, system 100 may couple to a hard drive, e.g., data storage 2028 in FIG. 20.

Memory 108 may include operating system (OS) and/or virtual machine monitor (VMM) code 110, user (e.g., program) code 112, non-trust domain memory 114 (e.g., pages), trust domain memory 116 (e.g., pages), uncompressed data (e.g., pages), compressed data (e.g., pages), or any combination thereof. In some examples of computing, a VM is an emulation of a computer system. In some examples, VMs are based on a specific computer architecture and provide the functionality of an underlying physical computer system. VM implementations may involve specialized hardware, firmware, software, or a combination. In some examples, a VMM (also known as a hypervisor) may be a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates creation of VMs, e.g., each with separate OSs and applications. The VMM may manage the backend operation of these VMs by allocating the necessary computing, memory, storage, and other I/O resources, such as, but not limited to, an I/OMMU (e.g., I/OMMU 120). The VMM may provide a centralized interface for managing the entire operation, status, and availability of VMs that are installed on a host machine that includes system 100.

According to some examples, memory 108 may be memory separate from a core and/or I/O device(s) 106. Memory 108 may include volatile types of memory such as, but not limited to, DRAM or static random access memory (SRAM). Compressed data may be stored in a first memory device (e.g., configured as far memory 146) and/or uncompressed data may be stored in a separate, second memory device (e.g., configured as near memory).

In some examples, a coupling (e.g., via input/output (I/O) fabric interface 104) may be included to allow communication between I/O device(s) 106, core(s) 102-0 to 102-N, memory 108, etc. As described more below, secured links may be established through a I/O fabric interface 104 for communication between I/O device(s) 106 and trusted domain elements managed by trust domain manager 101 (e.g., a TPA TD) or between I/O device(s) 106 and S3M 138 using links operated according to the PCIe specification, operated according to the System Management Bus (SMBus) Specification, Ver. 3.1, published in March 2018, (“the SMBus specification”) or operated according to the Compute Express Link Specification, Rev. 2.0, Ver. 1.0, published Oct. 26, 2020, (“the CXL specification”).

According to some examples, a hardware initialization manager (non-transitory) storage 118 may store hardware initialization manager firmware (e.g., or software). In some examples, hardware initialization manager (non-transitory) storage 118 stores Basic Input/Output System (BIOS) firmware. In other examples, hardware initialization manager (non-transitory) storage 118 may store Unified Extensible Firmware Interface (UEFI) firmware. In certain examples (e.g., triggered by the power-on or reboot of a processor), computer system 100 (e.g., core 102-0) executes the hardware initialization manager firmware (e.g., or software) stored in hardware initialization manager (non-transitory) storage 118 to initialize the system 100 for operation, for example, to begin executing an operating system (OS) and/or initialize and test the (e.g., hardware) components of system 100.

In some examples, system 100 includes an I/O memory management unit (I/OMMU) 120 (e.g., circuitry), e.g., coupled between one or more cores 102-0 to 102-N and I/O fabric interface 104. In certain examples, I/OMMU 120 provides address translation, for example, from a virtual address to a physical address. In certain examples, I/OMMU 120 includes one or more registers 121, for example, data registers and/or control registers.

According to some examples, I/O device(s) 106 may include any of the depicted components. For example, with one or more instances of an accelerator circuit 106-0 to 106-N. In certain examples, a job (e.g., corresponding descriptor for that job) is submitted to and I/O device from among I/O device(s) 106 and the I/O device is to perform one or more (e.g., decompression or compression) operations. Also, I/O device(s) 106 may be a TEE capable I/O device, for example, with the host (e.g., processor including one of more of cores 102-0 to 102-N) being a TEE capable host. In certain examples, a TEE capable host implements a TSM.

In some examples, a TSM (e.g., jointly implemented by a trust domain manager 101 and S3M 138) is to: provide interfaces to the VMM to assign memory, processor, and other resources to TDs (e.g., trusted virtual machines), (ii) implement the security mechanisms and access controls (e.g., I/OMMU translation tables, etc.) to protect confidentiality and integrity of the TDs' (e.g., trusted virtual machines) data and execution state in the host from entities not in the trusted computing base of the TDs (e.g., trusted virtual machines), (iii) uses a protocol to manage the security state of the trusted device interface (TDI) to be used by the TDs (e.g., trusted virtual machines), (iv) establish/manage integrity and data encryption (IDE) keys for the host, and, if needed, schedule IDE key refreshes. For these examples, the TSM programs the IDE encryption keys into the host root ports and communicates with a devices security manager (DSM) at the TEE capable I/O device (e.g., DSM 136 of I/O device(s) 106) to configure IDE encryption keys in the TEE capable I/O device, (v) or any single or combination thereof.

According to some examples, DSM 136 is to (i) support authentication of I/O device(s) 106 identities and measurement reporting, (ii) configure IDE encryption keys in I/O device(s) 106 (e.g., where a TSM provides the keys for the initial configuration and subsequent key refreshes to a DSM), (iii) provide device interface management for locking TDI configuration, reporting TDI configurations, attaching, and detaching TDIs to TDs (e.g., trusted virtual machines), (iv) implements access control and security mechanisms to isolate TDs (e.g., trusted virtual machine) provided data from entities not in the TCB of a TD (e.g., a trusted virtual machine), (v) or any single or combination thereof. In some examples, DSM 136 is a circuit or circuitry (e.g., microcontroller, application specific integrated circuit (ASIC), or field programmable gate array (FPGA)) (e.g., separate or a part of accelerator circuit 106) with read-only memory (ROM) and random-access memory (RAM) for firmware execution

In some examples, as shown in FIG. 1, circuitry of DSM 136 may be configured or arranged to implement or execute an authentication (auth.) logic 135 or an attestation (attest.) logic 137. As described more below, authentication logic 135 may facilitate establishment of a secure session (e.g., a SPDM session) with entities in the TCB of a TD (e.g., a TPA TD) via a link operated according to the PCIe specification. Also, as described more below, attestation logic 137 may facilitate establishment of a separate secure session (e.g., second SPDM session) with S3M 138 via a second link operated according to the SMBus specification. The separate secure sessions, for example, to enable an I/O device that includes DSM 136 to have an ability to implement mutual authentication in a confidential computing environment.

In some examples, S3M 138 is a circuit (e.g., microcontroller, ASIC, or FPGA), separate from cores 102, with read-only memory (ROM) and random-access memory (RAM) for firmware execution. In certain examples, system 100 includes an in-package complex programmable logic device (CPLD) or FPGA which provides non-volatile RAM to store code and the CPLD/FPGA is shared by multiple S3M circuits of a (e.g., central processing unit (CPU) or processor that include cores 102) die. According to some examples, as shown in FIG. 1, S3M 138 includes an authentication logic 133 and an attestation logic 139. As described more below, authentication logic 133 and attestation logic 139 may be arranged to work with logic and/or features of DSM 136 at I/O device 106 such as authentication logic 135 or attestation logic 137 to facilitate implementation of mutual authentication in a confidential computing environment.

According to some examples, S3M 138 supports I/O controller functions (e.g., through a combination of hardware and firmware), e.g., for Universal Asynchronous Receiver Transmitter (UART) devices, Serial Peripheral Interface (SPI) devices, System Management Bus (SMBus) devices, etc.

In some examples, an on-die S3M 138 may access the (e.g., Peripheral Component Interconnect (PCI)) configuration space for a device under the (e.g., PCI) host bridge in same die so that logic and/or features of S3M 138 can send messages (e.g., SPDM messages) via a (e.g., PCIe) Data Object Exchange (DOE) mailbox. Additionally or alternatively, S3M 138 may access an SMBus interface included in I/O fabric interface(s) 104 to send (e.g., SPDM) communications, e.g., via a Management Component Transport Protocol (MCTP) message.

According to some examples, S3M 138 may be used during platform boot. For example, the platform hardware initialization manager (e.g., BIOS or UEFI) is to communicate with S3M 138 and let S3M 138 send (e.g., SPDM) message to other I/O device(s) 106 to collect the measurement. In certain examples, S3M may help to setup a SPDM session (e.g., and transport the IDE key). In some examples, this boot time session has no relationship or interaction with setting up an instance of a secure communication session with an I/O device included in I/O device(s) 106.

In some examples, a standard or specification defines a virtual machine monitor (VMM) (e.g., or VM thereof), TSM (e.g., trust domain manager 101), and device security manager (DSM) 136 interaction flow. The standard or specification may include, but is not limited to, a specification published by Intel® entitled “Architecture Specification: Intel® Trust Domain Extensions (Intel® TDX) Module”, published in August 2021, (“the TDX-IO architecture specification”) and/or other standards or specification related to this Intel® TDX architecture specification.

According to some examples, I/OMMU 120 and trust domain manager(s) 101 cooperate to allow for direct memory access (e.g., directly) between (e.g., to and/or from) I/O device(s) 106 and trust domain memory 116 (e.g., a region for only a single trust domain and/or another region shared by a plurality of trust domains).

In some examples, in order to establish a trust relationship between an I/O device such as an I/O device from among I/O device(s) 106 and a TD, certain TDX-IO architectures require the TD and/or a trust domain manager (e.g., circuit and/or code) (e.g., Trusted Execution Environment (TEE) security manager (TSM)) to create a secure communication session between the I/O device and the trust domain manger (e.g., for the trust domain manger to allow a particular TD to use the I/O device or a subset of function(s) of the I/O device). In order to establish the trust relationship between an I/O device and a TD, certain TDX-IO architectures require the TD and/or a trust domain manager (e.g., circuit and/or code) (e.g., TSM) use (i) the SPDM specification to authenticate the device (e.g., and collect device measurement), and (ii) use TDISP as described in PCI-SIG published standards or specification to communicate with a DSM (e.g., DSM 136) to manage the I/O device's function(s).

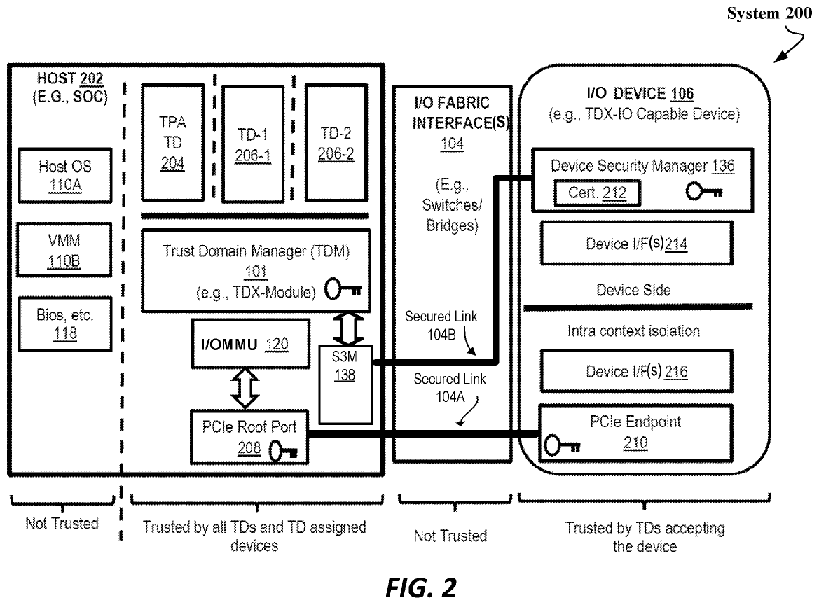

FIG. 2 illustrates an example system 200. As shown in FIG. 2, system 200 includes a host 202 (e.g., a system on a chip (SOC)). Host 202, for example, may be one or more processor cores (e.g., cores 102-0 to 102-N shown in FIG. 1) coupled to an I/O device 106 according to examples of this disclosure. As mentioned above for system 100, system 200 may also be part of a computer system that implement techniques associated with a TDX-IO architecture and system 200 may also be on a single host computer system (e.g., a host server or platform).

According to some examples, host 202 implements TDX-IO provisioning agent (TPA) TD 204 and a plurality of TDs, shown as TD-1 206-1 and TD-2 206-2, although any single or plurality of TDs may be implemented. In some examples, as shown in FIG. 2, Host 202 includes a trust domain manager (TDM) 101 (also referred to as a TDX-module) to manage the plurality of TDs (for example, with the vertical dashed lines of FIG. 2 indicating isolation therebetween TDs and host OS 110A, VMM 110B, and BIOS 118.

In some examples, VMM 110B manages (e.g., generates) one or more VMs, e.g., with the trust domain manager 101 isolating a first VM as a first TD (e.g., TD-1 206-1) from a second (or more) VM and second (or more) TD(s) (e.g., TD-2 206-2).

According to some examples, host 202 includes a (e.g., PCIe) root port 208 having a key (shown symbolically in FIG. 2) to allow secure communications with I/O device 106, e.g., with a PCIe endpoint 210 thereof (e.g., also having the key (shown symbolically in FIG. 2)). In some examples, trust domain manager 101 and device security manager 136 are also to have a key, e.g., representing a memory protection key and a secure session key, respectively.

In some examples, host 202 is coupled to I/O device 106 via an I/O interface 104 as shown in FIG. 2. For these examples, a first coupling or connection via I/O interface(s) 104 may include a secured link 104A that may be established and/or maintained according to the PCIe specification and/or the CXL specification and is routed between PCIe root port 208 and PCIe endpoint 210 as shown in FIG. 2. Also, as shown in FIG. 2, a second coupling or connection via I/O interface(s) 104 may include a secured link 104B that may be established and/or maintained according to the SMBus specification and is routed between S3M 138 and device security manager 136 of I/O device 106.

According to some examples, host 202 may be coupled to one or more device interface(s) (I/F(s)) 216 of I/O device 106 according to a transport level specification (e.g., the SPDM specification) and/or an application level (e.g., TDISP) specification. In some examples, DSM 136 of I/O device 106 may maintain device secret(s) (e.g., session key) or device public properties (e.g., device certificate 212, device “measurement” values, etc.). In some examples, I/O device 106 may implement one or more physical function(s) that may be offloaded to I/O device 106 from host 202.

In some examples, as shown in FIG. 2, I/O device 106 includes one or more device I/F(s) 214 on a device side, and one or more device interface(s) 216 that is isolated from device I/F(s) 214 via an intra context isolation supported by I/O device 106.

According to some examples, I/O device 106 (e.g., according to a single-root input/output virtualization (SR-IOV) standard) may be shared by a plurality of VMs (e.g., arranged in respective TDs). For these examples, a physical function has an ability to move data in and out of an I/O device while virtual functions (for example, first virtual function and second virtual function, e.g., where the virtual functions are lightweight (e.g., PCIe) functions that support data flowing but also have a restricted set of configuration resources.

In some examples, I/O device 106 may perform a direct memory access (DMA) request to a private memory of a TD (e.g., TD-1 206-1 or TD-2 206-2) under the control of I/OMMU 120.

According to some examples, a TD has both a private memory (e.g., in trust domain memory 116—see FIG. 1) and a shared memory (e.g., in non-trust domain memory 114 and/or trust domain memory 116—see FIG. 1). In some examples, direct memory accesses (DMAs) may target protected memory (e.g., private memory) or shared memory of a TD.

According to some examples, a system such as system 200 that has a TD such as TD-1 206-1 establishes a trusted connection via a secured link such as secured link 104A with an I/O device such as I/O device 106 according to the SPDM specification and the TDX-IO architecture specification. Also, a trusted device interface security protocol (TDISP) may be used to manage I/O device 106 and enable memory-mapped I/O (MMIO) and DMA with the I/O device 106. Also, an integration and data encryption (IDE) protocol may be used in accordance with the PCIe specification and/or the CXL specification to secure a link between the I/O device and a root port (e.g., PCIe root port 208) at the host supporting the TD.

In some example special use cases, an I/O device such as I/O device 106 may want to authenticate host 202 to determine if any offload requests (e.g., associated with MMIO or DMA communications) from host 202 are from a trusted entity. This is called mutual authentication. Mutual authentication is not a new concept. Industry standards that describe the use of TLS or SPDM require the entity (e.g., host software) to be authenticated to have a private key or be deployed with a pre-shared key (PSK). Having a private key or deployed with a PSK is hard to implement in a TDX-IO context. Remote types of attestation such as RA-TLS is a possible solution in a TDX-IO context for mutual authentication. But RA-TLS is likely to be a complicated processes when implemented in a TDX-IO context. A Simpler type of attestation is described more below that utilizes secured link 104A as an authentication channel to have I/O device 106 set up a secure communication with TPA TD 204. TPA TD 204 will then obtain a TD REPORT that includes information about TDM 101 and information about TPA TD 204 information and send the TD_REPORT to I/O device via secured link 104A for use in mutual authentication. A simpler type of local attestation (compared to RA-TLS) next utilizes secured link 104B as an attestation channel to have I/O device 106 verify host 202 in cooperation with logic and/or features of S3M 138, such as attestation logic 139. The use of an authentication channel and an attestation channel extends a typical TDX-IO one-way authentication to a type of mutual authentication that is localized and does not rely on a remote host server for attestation.

In some examples, I/O device 106 may include, but is not limited to, an accelerator device, a memory device or a storage device. For these examples, a memory or storage device may include volatile and/or non-volatile types of memory.

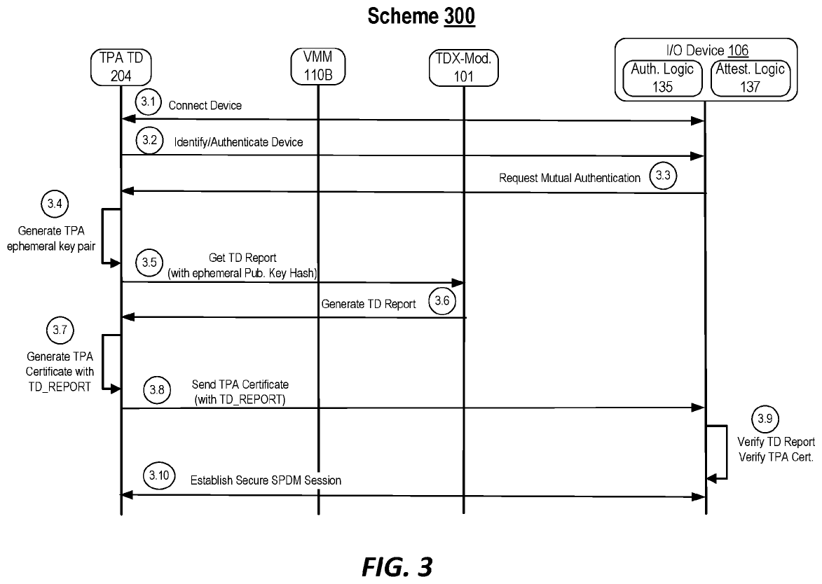

FIG. 3 illustrates an example scheme 300 associated with activity in an authentication channel for mutual authentication. According to some examples, in a TDX-IO architecture, such as shown in FIGS. 1-2 for systems 100 and 200, a VMM (such as VMM 110B) launches a TPA TD (such as TPA TD 204) to create a secure connection (such as secured link 104A) between a device (such as I/O device 106) and a trust domain manager of a host (such as TDM 101 of host 202). For these examples, at 3.1, TPA TD 204 may use commands/requests according to the SPDM specification that include, but are not limited to, GET_VERSION, GET_CAPABILITY and NEGOTIATE ALGORITHM to build a connection with I/O device 106. For example, a first connection may be built between host 202 and I/O device 106 to be used for the authentication channel (e.g., routed through a PCIe/CXL interface included in I/O fabric interface(s) 104). GET_VERSION may ask for what SPDM version is supported by I/O device 106, GET_CAPABILITY may ask for what device capabilities I/O device 106 may have, and NEGOTIATE_ALGORITHM may ask/negotiate what security algorithm may be used for establishing the first connection for the authentication channel.

In some examples, at 3.2, TPA TD 204 then uses other SPDM specification commands/requests to identify/authenticate I/O device 106. For these examples, the other SPDM specification commands/requests may include GET_Certificate to get a device identity from I/O device 106 and KEY_EXCHANGE to request a start to a secure session creation with I/O device 106.

According to some examples, at 3.3, authentication logic 135 of I/O device 106, responsive to the GET_CERTIFICATE AND KEY_EXCHANGE commands/requests, returns a KEY_EXCHANGE_RSP response and also places a request to TPA TD 204 for mutual authentication.

In some examples, at 3.4, TPA TD 204 generates an ephemeral key pair. For these examples, the generated ephemeral key pair is short-term key pair intended just for the establishment of the secure connection.

According to some examples, at 3.5, TPA TD 204 asks for a TD REPORT from TDX-module 101. For these examples, the TD_REPORT includes a hash of an ephemeral public key associated with the generated ephemeral key pair. As describe more below, the hash of the ephemeral public key may help I/O device 106 to verify the ephemeral key. The TD REPORT, for example, may also include a digitally signed digest of contents of selected values within TDX-module 101. The selected values may include, but are not limited to, evidence of a platform configuration in a platform configuration register (PCR), audit logs, or key properties of TDM 101.

In some examples, at 3.6, TDX-module 101 sends the TD_REPORT to TPA TD 204.

According to some examples, at 3.7, TPA TD 204 generates a TPA certificate with TD REPORT. For these examples, the TD_REPORT that was received from TDX-module 101 at 3.6 may be found in the TPA certificate with a special Object ID (OID). In some other examples, the TPA TD may send the TD_REPORT to a TDX Quoting Enclave and get the TD_Quote, and generate the TPA certificate with the TD_Quote. In another example, the TPA TD may send the TD_REPORT or TD_Quote to a device vendor specific verification service and get the final TICKET from the verification service, and generate the TPA certificate with the TICKET. The TD_REPORT, TD_Quote, or TICKET should have cryptographic integrity protection, such as message authentication code (MAC) or digital signature, and replay protection, such as a nonce.

In some examples, at 3.8, TPA TD 204 sends the TPA certificate to I/O device 106 via an SPDM encapsulated CERTIFICATE response message.

According to some examples, at 3.9, attestation logic 137 of I/O device 106 may verify the TPA certificate and the TD_REPORT, TD_QUOTE or TICKET included in the TPA certificate. This verification process by attestation logic is described more below for scheme 400.

In some examples, at 3.10, after attestation logic 137 of I/O device 106 accepts the TPA certificate, authentication logic 135 of I/O device 106 can verify a digital signature in an SPDM message to authenticate TPA TD 204 and/or TSM 101 and thus establishes a secure SPDM session or connection with TPA TD 204 and/or trust domain manager 101, e.g., through secured link 104A. Scheme 300 may then come to an end.

In some other examples, mutual authentication may take two phases. The first step is that the TPA sets up a secure session with the device, with one way authentication, with only TPA verifying the device. The second step is that the device starts the authentication to the TPA. In another example, a device may want to authenticate the TD besides TPA. In this case, the second step is that the device sends the authentication request to the TD besides TPA. The TD may follow the same process as TPA, to generate a CERTIFICATE with TD specific TD_REPORT, TD_Quote or TICKET and send to the device.

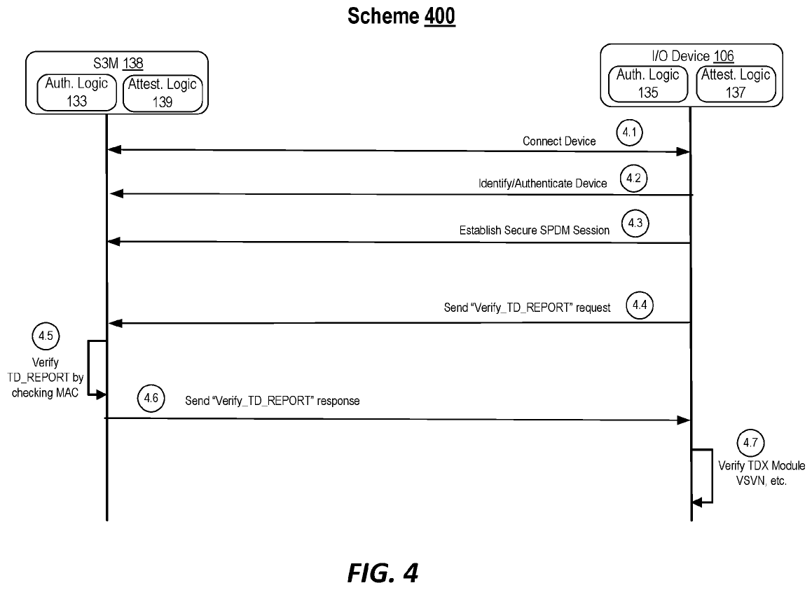

FIG. 4 illustrates an example scheme 400 associated with activity in an attestation channel for mutual authentication. According to some examples, in a TDX-IO architecture, such as shown in FIGS. 1-2 for systems 100 and 200. For these examples, scheme 400 describes a process via which an I/O device such as I/O device 106 sets up a secure SPDM session (e.g., via secure link 104B) between an S3M such as S3M 138 having authorization logic and/or features such as authorization logic 133 and the I/O device having logic and/or features such as authorization logic 135 to set up the secure SPDM session. Attestation logic and/or features of the I/O device such as attestation logic 137 may then use attestation logic and/or features of the S3M as a trust agent (e.g., attestation logic 139) to verify a

TD REPORT that was included in a TPA certificate received by the I/O device as described above for scheme 300, at 3.9.

In some examples, at 4.1, S3M 138 may use commands/requests according to the SPDM specification that include, but are not limited to, GET_VERSION, GET CAPABILITY and NEGOTIATE ALGORITHM to build a connection with I/O device 106. For example, a second connection may be built between host 202 and I/O device 106 to be used for the attestation channel (e.g., routed through an SMBus interface included in I/O fabric interface(s) 104). GET_VERSION may ask for what SPDM version is supported by I/O device 106, GET_CAPABILITY may ask for what device capabilities I/O device 106 may have, and NEGOTIATE_ALGORITHM may ask/negotiate what security algorithm may be used for establishing the second connection for the attestation channel.

According to some examples, at 4.2, S3M 138 then uses other SPDM specification commands/requests to identify/authenticate I/O device 106. For these examples, the other SPDM specification commands/requests may include GET_CERTIFICATE to get a device identity from I/O device 106 and KEY_EXCHANGE to request a start to a secure session creation with I/O device 106.

In some examples, at 4.3, authentication logic 135 of I/O device 106, responsive to the GET CERTIFICATE AND KEY EXCHANGE commands/requests, returns a KEY EXCHANGE_RSP response that eventually leads to establishment of a secure connection between S3M 138 and I/O device 106, e.g., via secure link 104B. For these examples, this secure connection may serve as a second secure connection between host 202 and I/O device 106 that is to be used as an attestation channel as described more below.

According to some examples, at 4.4, attestation logic 137 of I/O device 106 sends a Verify_TD_REPORT request to S3M 138 via the secure connection serving as an attestation channel. For these examples, as mentioned above for scheme 300, at 3.8, I/O device 106 received the TD REPORT in a TPA certificate sent by TPA TD 204 via the first secure connection that served as an authentication channel. Attestation logic 137 may have parsed the OID in the TPA certificate to extract the TD REPORT.

In some examples, at 4.5, attestation logic 139 of S3M 138 verifies the TD_REPORT responsive to the Verify_TD_REPORT request. For these examples, attestation logic 139 may cause S3M 138 to issue a local attestation ISA to host 202 to check an integrity of a message authentication code (MAC) in the TD_REPORT to verify the TD_REPORT. The local attestation ISA to host 202 may be similar to an EVERYIFYREPORT2 ISA. For example, the local attestation ISA to host 202 may be a special mode-specific register (MSR) Write (e.g., EVERYIFYREPORT2_MSR) action, where an MSR at host 202 stores or holds the TD_REPORT.

According to some examples, at 4.6, attestation logic 139 of S3M 138 sends a Verify_TD_REPORT response to I/O device 106. For these examples, the Verify_TD_REPORT response indicates whether the TD_REPORT passed verification.

In some examples, if attestation logic 137 of I/O device 106 determines that the response received from S3M 138 indicated that the TD_REPORT passed verification, I/O device 106 can trust the TD_REPORT and can verify details included in the TD_REPORT such as trusted computing base information (TCB_INFO) or TD information (TD_INFO). Logic and/or features of I/O device 106 such as authentication logic 135 or attestation logic 137 may also verify the TPA certificate by checking a digital signature of the TPA certificate (e.g., using the hash of the ephemeral public key), and extract/parse more OIDs in the TPA certificate such as a TD Event log. Scheme 400 may then come to an end.

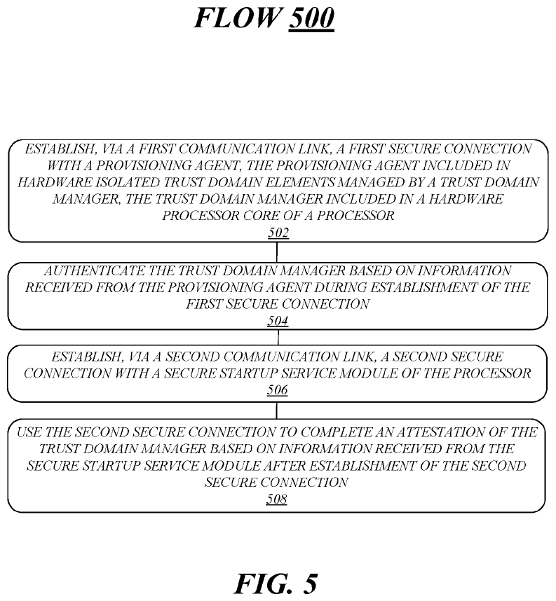

FIG. 5 illustrates an example logic flow 500. Logic flow 500 may be representative of the operations implemented by logic and/or features of circuitry at an I/O device. For example, DSM 136 may include authentication logic 135 and attestation logic 137 as shown in FIGS. 1 and 3-4 and described above. Examples are not limited to the components shown in FIG. 3 and described above.

In some examples, as shown in FIG. 5, logic flow 500 at block 502 may establish, via a first communication link, a first secure connection with a provisioning agent (such as TPA TD 204), the provisioning agent included in hardware isolated trust domain elements managed by a trust domain manager, the trust domain manager included in a hardware processor core of a processor. For these examples, authentication logic 135 may establish the first secure session with the provisioning agent (e.g., TPA TD 204).

According to some examples, logic flow 500 at block 504 may authenticate the trust domain manager based on information received from the provisioning agent during establishment of the first secure connection. For these examples, authentication logic 135 may authenticate the trust domain manager (e.g., TDX-module 101).

In some examples, logic flow 500 at block 506 may establish, via a second communication link, a second secure connection with a secure startup service module of the processor. For these examples, authentication logic 135 may also establish the second communication link with the secure startup service module (e.g., S3M 138).

According to some examples, logic flow 500 at block 508 may use the second secure connection to complete an attestation of the trust domain manager based on information received from the secure startup service module after establishment of the second secure connection. For these examples, attestation logic 137 may complete the attestation of the trust domain manager.

The schemes and flow shown in FIGS. 3-5 may be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A scheme or flow may be implemented in software, firmware, and/or hardware. In software and firmware embodiments, a software or logic flow may be implemented by computer executable instructions stored on at least one non-transitory computer readable medium or machine readable medium, such as an optical, magnetic or semiconductor storage. The embodiments are not limited in this context.

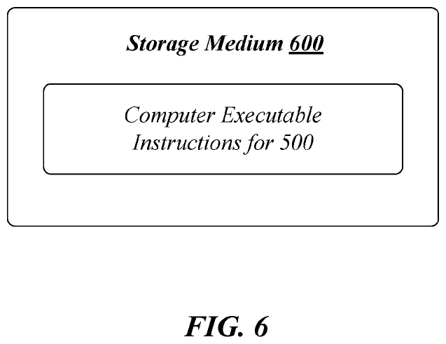

FIG. 6 illustrates an example of a storage medium. As shown in FIG. 6, the storage medium includes a storage medium 600. The storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

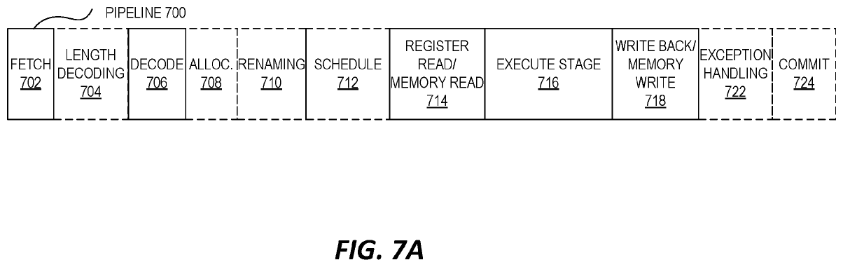

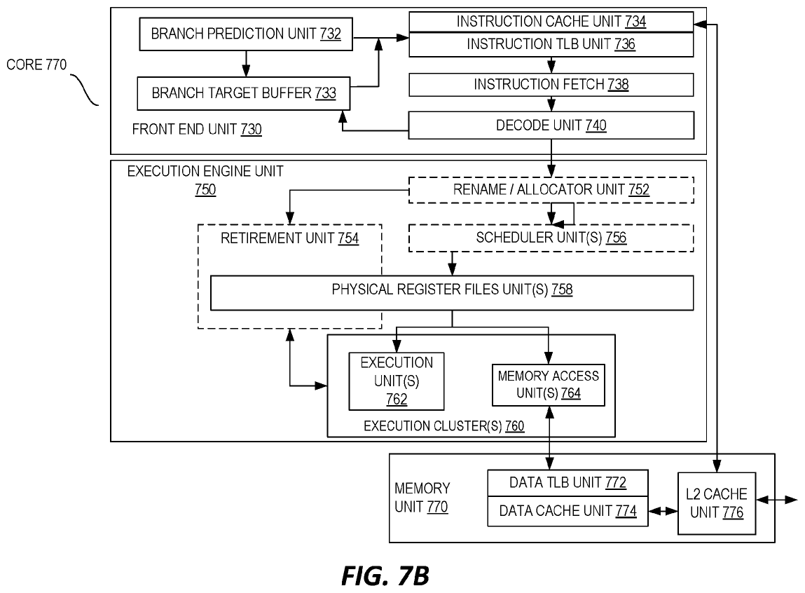

Understand that examples may be used in connection with many different processor architectures. FIG. 7A is a block diagram illustrating both an example in-order pipeline and an example register renaming, out-of-order issue/execution pipeline according to various examples. FIG. 7B is a block diagram illustrating both an example of an in-order architecture core and an example register renaming, out-of-order issue/execution architecture core to be included in a processor according to various examples. In various examples, the described architecture may be used to implement a write operation performed by an I/O agent in an I/O domain at a compute domain shared cache hierarchy. The solid lined boxes in FIGS. 7A and 7B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724. Note that as described herein, in a given example a core may include multiple processing pipelines such as pipeline 700.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In some examples, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

As further shown in the front end unit 730, the branch prediction unit 732 provides prediction information to a branch target buffer 733.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one example, the physical register file(s) unit 758 includes a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scheduler unit(s) 756, physical register file(s) unit(s) 758, and execution cluster(s) 760 are shown as being possibly plural because certain examples create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain examples are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one example, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the example register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In some examples, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated example of the processor also includes separate instruction and data cache units 734/774 and a shared L2 cache unit 776, alternative examples may have a single internal cache for both instructions and data, such as, for example, a level 1 (L1) internal cache, or multiple levels of internal cache. According to some examples, the system may include a combination of an internal cache and an external cache that is external to the core and/or the processor. Alternatively, all of the cache may be external to the core and/or the processor. Note that an example of the execution engine unit 750 described above may place a cache line in the shared L2 cache unit 776 or the L1 internal cache in a placeholder state in response to a request for ownership of the cache line from an I/O agent in an I/O domain thereby reserving the cache line for the performance of a write operation by the I/O agent using examples herein.

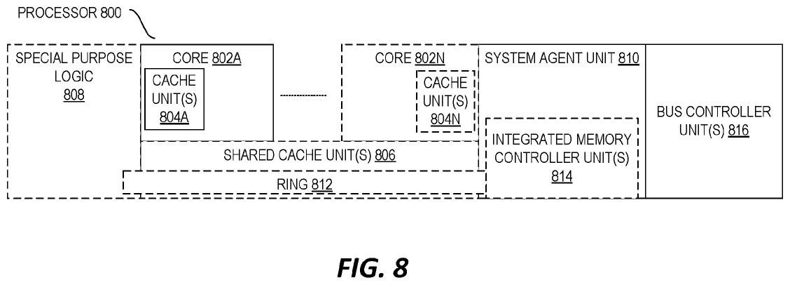

FIG. 8 is a block diagram of a processor 800 that may have more than one core, may have an integrated memory controller, and may have integrated graphics according to various examples. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-N, a set of one or more integrated memory controller unit(s) in the system agent unit 810, and a special purpose logic 808, which may perform one or more specific functions.

Thus, different implementations of the processor 800 may include: 1) a CPU with a special purpose logic being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache units 804A-N within the cores, a set or one or more shared cache units 806, and external memory (not shown) coupled to the set of integrated memory controller units 814. The set of shared cache units 806 may include one or more mid-level caches, such as L2, L3, L4, or other levels of cache, a last level cache (LLC), and/or combinations thereof. While in one example a ring based interconnect unit 812 interconnects the special purpose 808, the set of shared cache units 806, and the system agent unit 810/integrated memory controller unit(s) 814, alternative examples may use any number of well-known techniques for interconnecting such units.

The system agent unit 810 includes those components coordinating and operating cores 802A-N. The system agent unit 810 may include for example a power control unit (PCU) and a display unit. The PCU may be or include logic and components needed for regulating the power state of the cores 802A-N and the special purpose logic 808. The display unit is for driving one or more externally connected displays.

The cores 802A-N may be homogenous or heterogeneous in terms of architecture instruction set; that is, two or more of the cores 802A-N may be capable of execution of the same instruction set, while others may be capable of executing only a subset of that instruction set or a different instruction set. In some examples, a cache line in one of the shared cache units 806 or one of the core cache units 804A-804N may be placed in a placeholder state in response to a cache line ownership request received from an I/O agent in an I/O domain thereby reserving the cache line for the performance of a write operation by the I/O agent as described herein.

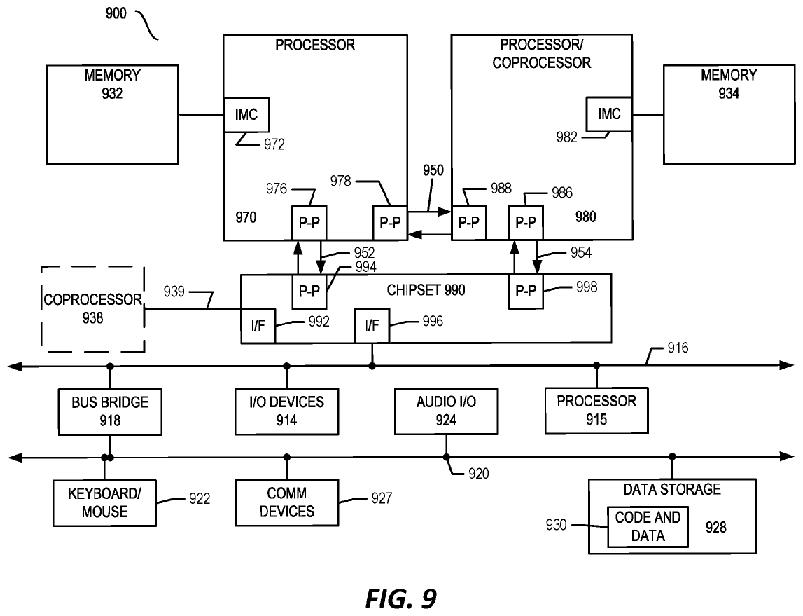

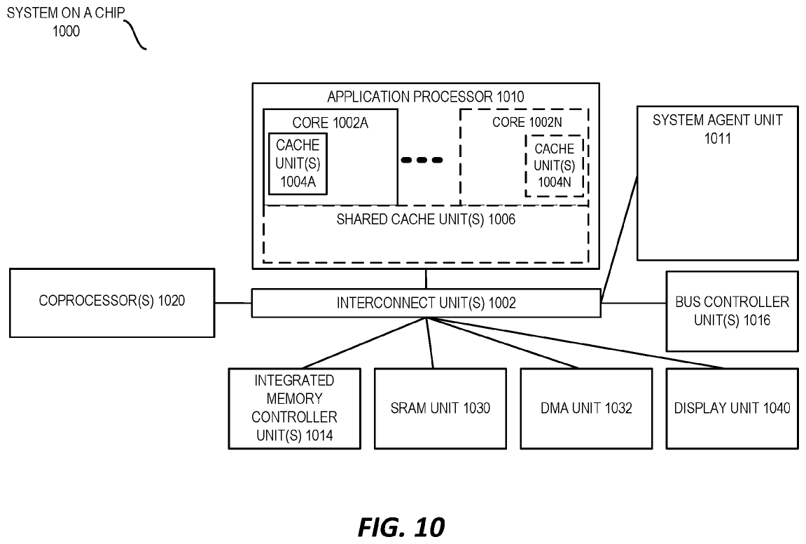

FIGS. 9-10 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a large variety of systems or electronic devices capable of incorporating a processor and/or other execution logic as disclosed herein are generally suitable.

Referring now to FIG. 9, shown is a block diagram of a first more specific example system 900. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 900.

Processors 970 and 980 are shown including integrated memory controller (IMC) units 972 and 982, respectively. Processor 970 also includes, as part of its bus controller units, point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, integrated memory controllers (IMCs) 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 939. According to some examples, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors yet connected with the processors via P-P interconnect, such that either or both processors' local cache information may be stored in the shared cache if a processor is placed into a low power mode. In some examples, a cache line in the shared cache or the local cache may be placed in a placeholder state in response to an ownership request from an I/O agent in an I/O domain thereby reserving the cache line for the performance of a write operation by the I/O agent.

Chipset 990 may be coupled to a first bus 916 via an interface 996. In some examples, first bus 916 may be a Peripheral Component Interconnect (PCI) bus, or a bus such as a PCI Express bus or another third generation I/O interconnect bus, although the scope is not so limited.

As shown in FIG. 9, various I/O devices 914 may be coupled to first bus 916, along with a bus bridge 918 which couples first bus 916 to a second bus 920. According to some examples, one or more additional processor(s) 915, such as coprocessors, high-throughput MIC processors, GPGPU's, accelerators (such as, e.g., graphics accelerators or digital signal processing (DSP) units), field programmable gate arrays, or any other processor, are coupled to first bus 916. In one example, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one example. Further, an audio I/O 924 may be coupled to the second bus 920. Note that other architectures are possible. For example, instead of the point-to-point architecture of FIG. 9, a system may implement a multi-drop bus or other such architecture.

Referring now to FIG. 10, shown is a block diagram of a SoC 1000 in accordance with an example. Dashed lined boxes are optional features on more advanced SoCs. In FIG. 10, an interconnect unit(s) 1002 is coupled to: an application processor 1010 which includes a set of one or more cores 1002A-N (including constituent cache units 1004A-N); shared cache unit(s) 1006; a system agent unit 1012; a bus controller unit(s) 1016; an integrated memory controller unit(s) 1014; a set or one or more coprocessors 1020 which may include integrated graphics logic, an image processor, an audio processor, and a video processor; a static random access memory (SRAM) unit 1030; a direct memory access (DMA) unit 1032; and a display unit 1040 for coupling to one or more external displays. In one example, the coprocessor(s) 1020 include a special-purpose processor, such as, for example, a network or communication processor, compression engine, GPGPU, a high-throughput MIC processor, embedded processor, or the like. In various examples, a cache line in a constituent cache unit 1004A-N or in a shared cache unit 1006 may be placed in a placeholder state in response to an ownership request for a cache line from an I/O agent in an I/O domain thereby reserving the cache line for the performance of a write operation by the I/O agent.

Examples of the mechanisms disclosed herein may be implemented in hardware, software, firmware, or a combination of such implementation approaches. Various examples may be implemented as computer programs or program code executing on programmable systems comprising at least one processor, a storage system (including volatile and non-volatile memory and/or storage elements), at least one input device, and at least one output device.

Program code, such as code 1030 illustrated in FIG. 10, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

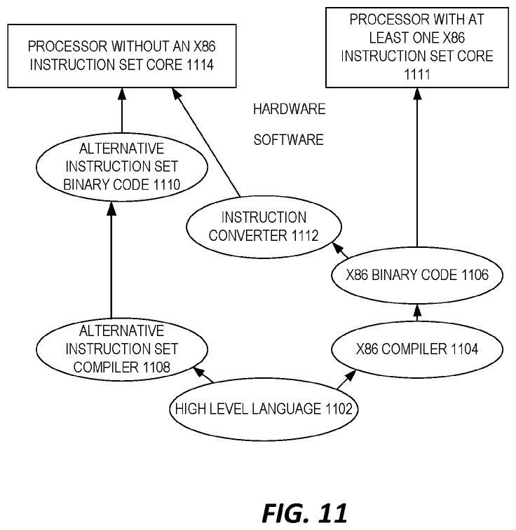

FIG. 11 is a block diagram contrasting the use of a software instruction converter to

convert binary instructions in a source instruction set to binary instructions in a target instruction set according to various examples. In the illustrated example, the instruction converter is a software instruction converter, although alternatively the instruction converter may be implemented in software, firmware, hardware, or various combinations thereof. FIG. 11 shows a program in a high level language 1102 may be compiled using an x86 compiler 1104 to generate x86 binary code 1106 that may be natively executed by a processor with at least one x86 instruction set core 1116. The processor with at least one x86 instruction set core 1116 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1104 represents a compiler that is operable to generate x86 binary code 1106 (e.g., object code) that can, with or without additional linkage processing, be executed on the processor with at least one x186 instruction set core 1116. Similarly, FIG. 11 shows the program in the high level language 1102 may be compiled using an alternative instruction set compiler 1108 to generate alternative instruction set binary code 1110 that may be natively executed by a processor without at least one x86 instruction set core 1114 (e.g., a processor with cores that execute the MIPS instruction set of MIPS Technologies of Sunnyvale, CA and/or that execute the ARM instruction set of ARM Holdings of Sunnyvale, CA). The instruction converter 1112 is used to convert the x86 binary code 1106 into code that may be natively executed by the processor without an x86 instruction set core 1114. This converted code is not likely to be the same as the alternative instruction set binary code 1110 because an instruction converter capable of this is difficult to make; however, the converted code will accomplish the general operation and be made up of instructions from the alternative instruction set. Thus, the instruction converter 1112 represents software, firmware, hardware, or a combination thereof that, through emulation, simulation, or any other process, allows a processor or other electronic device that does not have an x86 instruction set processor or core to execute the x86 binary code 1106

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus may include circuitry at an I/O device. The circuitry may establish, via a first communication link, a first secure connection with a provisioning agent. The provisioning agent may be included in hardware isolated trust domain elements managed by a trust domain manager. The trust domain manager may be included in a hardware processor core of a processor. The circuitry may also authenticate the trust domain manager based on information received from the provisioning agent during establishment of the first secure connection. The circuitry may also establish, via a second communication link, a second secure connection with a secure startup service module of the processor. The circuitry may also use the second secure connection to complete an attestation of the trust domain manager based on information received from the secure startup service module after establishment of the second secure connection.

Example 2. The apparatus of example 1, the first secure connection and the second secure connection may be separately established according to a SPDM specification.

Example 3. The apparatus of example 1, the information received from the provisioning agent may include a certificate for the provisioning agent and a trust domain report for the trust domain manager.

Example 4. The apparatus of example 3, the circuitry may also send, to the secure startup service module via the second secure connection, a request to verify the trust domain report included in the certificate received from the provisioning agent. For this example, the secure startup service module may verify the trust domain report via use of an integrity check of a message authentication code in the trust domain report. The circuitry may also receive an indication in the information received from the secure startup service module after establishment of the second secure connection that the trust domain report has been verified to enable the I/O device to complete the attestation of the trust domain manager.

Example 5. The apparatus of example 1, the first communication link may operate according to at least one of a PCIe specification or a CXL specification. Also, the second communication link may operate according to an SMBus specification.

Example 6. An example method may be implemented by an I/O device. The method may include establishing, via a first communication link, a first secure connection with a provisioning agent. The provisioning agent may be included in hardware isolated trust domain elements managed by a trust domain manager, the trust domain manager included in a hardware processor core of a processor. The method may also include authenticating the trust domain manager based on information received from the provisioning agent during establishment of the first secure connection. The method may also include establishing, via a second communication link, a second secure connection with a secure startup service module of the processor. The method may also include using the second secure connection to complete an attestation of the trust domain manager based on information received from the secure startup service module after establishment of the second secure connection.

Example 7. The method of example 6, the first secure connection and the second secure connection may be separately established according to a SPDM specification.

Example 8. The method of example 6, the information received from the provisioning agent may include a certificate for the provisioning agent and a trust domain report for the trust domain manager.

Example 9. The method of example 8, the method may also include the secure startup service module sending, to the secure startup service module via the second secure connection, a request to verify the trust domain report included in the certificate received from the provisioning agent. For this example, the secure startup service module may verify the trust domain report via use of an integrity check of a message authentication code in the trust domain report. The method may also include receiving an indication in the information received from the secure startup service module after establishment of the second secure connection that the trust domain report has been verified to enable the I/O device to complete the attestation of the trust domain manager.

Example 10. The method of example 6, the first communication link may operate according to at least one of a PCIe specification or a CXL specification and the second communication link may operate according to an SMBus specification.

Example 11. An example at least one machine-readable storage medium may include a plurality of instructions that in response to being executed by circuitry causes the circuitry to carry out a method according to any one of examples 6 to 10.

Example 12. An example apparatus may include means for performing the methods of any one of examples 6 to 10.

Example 13. An example at least one non-transitory machine-readable storage medium may include a plurality of instructions. The plurality of instruction, when executed by circuitry of an I/O device, cause the circuitry to establish, via a first communication link, a first secure connection with a provisioning agent, the provisioning agent included in hardware isolated trust domain elements managed by a trust domain manager. The trust domain manager may be included in a hardware processor core of a processor. The instructions may also cause the circuitry of the I/O device to authenticate the trust domain manager based on information received from the provisioning agent during establishment of the first secure connection;
establish, via a second communication link, a second secure connection with a secure startup service module of the processor. The instructions may also cause the circuitry of the I/O device to use the second secure connection to complete an attestation of the trust domain manager based on information received from the secure startup service module after establishment of the second secure connection.

Example 14. The at least one non-transitory machine-readable medium of example 13, the first secure connection and the second secure connection may be separately established according to a SPDM specification.

Example 15. The at least one non-transitory machine-readable medium of example 13, the information may be received from the provisioning agent includes a certificate for the provisioning agent and a trust domain report for the trust domain manager.

Example 16. The at least one non-transitory machine-readable medium of example 15, the instructions may also cause the circuitry of the I/O device to send, to the secure startup service module via the second secure connection, a request to verify the trust domain report included in the certificate received from the provisioning agent. For this example, the secure startup service module may verify the trust domain report via use of an integrity check of a message authentication code in the trust domain report. The instructions may also cause the circuitry of the I/O device to receive an indication in the information received from the secure startup service module after establishment of the second secure connection that the trust domain report has been verified to enable the I/O device to complete the attestation of the trust domain manager.

Example 17. The at least one non-transitory machine-readable medium of example 13, the first communication link may operate according to at least one of a PCIe specification or a CXL specification and the second communication link may operate according to an SMBus specification.

Example 18. An example system may include a hardware processor core of a processor to include a trust domain manager to manage a plurality of hardware isolated trust domain elements that include at least one virtual machine and a provisioning agent. The system may also include a first communication link between the hardware processor core and an I/O device. The provisioning agent may establish a first secure connection through the first communication link to enable the I/O device to authenticate the trust domain manager based on information received from the provisioning agent during establishment of the first secure connection. The system may also include a secure startup service module of the processor. The system may also include a second communication link between the hardware processor core and the I/O device. The secure startup service module may establish a second secure connection through the second communication link to enable the I/O device to complete an attestation of the trust domain manager based on information received from the secure startup service module after establishment of the second secure connection.

Example 19. The system of example 18, the first secure connection and the second secure connection may be separately established according to a SPDM specification.

Example 20. The system of example 18, the information received from the provisioning agent may include a certificate for the provisioning agent and a trust domain report for the trust domain manager.

Example 21. The system of example 20, the secure startup service module may also receive a request from the I/O device to verify the trust domain report included in the certificate received from the provisioning agent. The secure startup service module may also verify the trust domain report via use of an integrity check of a message authentication code in the trust domain report. The secure startup service module may also indicate via the information received from the secure startup service module after establishment of the second secure connection that the trust domain report has been verified to enable the I/O device to complete the attestation of the trust domain manager.

Example 22. The system of example 18, the first communication link may operate according to at least one of a PCIe specification or a CXL specification and the second communication link may operate according to an SMBus specification.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1-20. (canceled)

21. An apparatus comprising:
circuitry at an input/output (I/O) device, the circuitry to:
establish, via a first communication link, a first secure connection with a provisioning agent, the provisioning agent included in hardware isolated trust domain elements managed by a trust domain manager, the trust domain manager included in a hardware processor core of a processor;
authenticate the trust domain manager based on information received from the provisioning agent during establishment of the first secure connection;
establish, via a second communication link, a second secure connection with a secure startup service module of the processor; and
use the second secure connection to complete an attestation of the trust domain manager based on information received from the secure startup service module after establishment of the second secure connection.

22. The apparatus of claim 21, wherein the first secure connection and the second secure connection are separately established according to a Secure Protocol and Data Model (SPDM) specification.

23. The apparatus of claim 21, wherein the information received from the provisioning agent includes a certificate for the provisioning agent and a trust domain report for the trust domain manager.

24. The apparatus of claim 23, further comprising the circuitry to:
send, to the secure startup service module via the second secure connection, a request to verify the trust domain report included in the certificate received from the provisioning agent, wherein the secure startup service module is to verify the trust domain report via use of an integrity check of a message authentication code in the trust domain report; and
receive an indication in the information received from the secure startup service module after establishment of the second secure connection that the trust domain report has been verified to enable the I/O device to complete the attestation of the trust domain manager.

25. The apparatus of claim 21, comprising:
the first communication link to operate according to at least one of a Peripheral Component Interconnect Express (PCIe) specification or a Compute Express Link (CXL) specification; and
the second communication link to operate according to a System Management Bus (SMBus) specification.

26. A method implemented by an input/output (I/O) device, the method comprising:
establishing, via a first communication link, a first secure connection with a provisioning agent, the provisioning agent included in hardware isolated trust domain elements managed by a trust domain manager, the trust domain manager included in a hardware processor core of a processor;
authenticating the trust domain manager based on information received from the provisioning agent during establishment of the first secure connection;
establishing, via a second communication link, a second secure connection with a secure startup service module of the processor; and
using the second secure connection to complete an attestation of the trust domain manager based on information received from the secure startup service module after establishment of the second secure connection.

27. The method of claim 26, wherein the first secure connection and the second secure connection are separately established according to a Secure Protocol and Data Model (SPDM) specification.

28. The method of claim 26, wherein the information received from the provisioning agent includes a certificate for the provisioning agent and a trust domain report for the trust domain manager.

29. The method of claim 28, further comprising:
sending, to the secure startup service module via the second secure connection, a request to verify the trust domain report included in the certificate received from the provisioning agent, wherein the secure startup service module is to verify the trust domain report via use of an integrity check of a message authentication code in the trust domain report; and
receiving an indication in the information received from the secure startup service module after establishment of the second secure connection that the trust domain report has been verified to enable the I/O device to complete the attestation of the trust domain manager.

30. The method of claim 26, comprising:
the first communication link to operate according to at least one of a Peripheral Component Interconnect Express (PCIe) specification or a Compute Express Link (CXL) specification; and
the second communication link to operate according to a System Management Bus (SMBus) specification.

31. At least one non-transitory machine-readable storage medium, comprising a plurality of instructions, that when executed by circuitry of an input/output (I/O) device, cause the circuitry to:
establish, via a first communication link, a first secure connection with a provisioning agent, the provisioning agent included in hardware isolated trust domain elements managed by a trust domain manager, the trust domain manager included in a hardware processor core of a processor;
authenticate the trust domain manager based on information received from the provisioning agent during establishment of the first secure connection;
establish, via a second communication link, a second secure connection with a secure startup service module of the processor; and
use the second secure connection to complete an attestation of the trust domain manager based on information received from the secure startup service module after establishment of the second secure connection.

32. The at least one non-transitory machine-readable medium of claim 31, wherein the first secure connection and the second secure connection are separately established according to a Secure Protocol and Data Model (SPDM) specification.

33. The at least one non-transitory machine-readable medium of claim 31, wherein the information received from the provisioning agent includes a certificate for the provisioning agent and a trust domain report for the trust domain manager.

34. The at least one non-transitory machine-readable medium of claim 33, further comprising the instructions to cause the circuitry to:
send, to the secure startup service module via the second secure connection, a request to verify the trust domain report included in the certificate received from the provisioning agent, wherein the secure startup service module is to verify the trust domain report via use of an integrity check of a message authentication code in the trust domain report; and
receive an indication in the information received from the secure startup service module after establishment of the second secure connection that the trust domain report has been verified to enable the I/O device to complete the attestation of the trust domain manager.

35. The at least one non-transitory machine-readable medium of claim 31, comprising:
the first communication link to operate according to a Peripheral Component Interconnect Express (PCIe) specification or a Compute Express Link (CXL) specification; and the second communication link to operate according to a System Management Bus (SMBus) specification.

36. A system comprising:
a hardware processor core of a processor to include a trust domain manager to manage a plurality of hardware isolated trust domain elements that include at least one virtual machine and a provisioning agent;
a first communication link between the hardware processor core and an input/output (I/O) device, wherein the provisioning agent is to establish a first secure connection through the first communication link to enable the I/O device to authenticate the trust domain manager based on information received from the provisioning agent during establishment of the first secure connection;
secure startup service module of the processor; and
a second communication link between the hardware processor core and the I/O device, wherein the secure startup service module is to establish a second secure connection through the second communication link to enable the I/O device to complete an attestation of the trust domain manager based on information received from the secure startup service module after establishment of the second secure connection.

37. The system of claim 36, wherein the first secure connection and the second secure connection are separately established according to a Secure Protocol and Data Model (SPDM) specification.

38. The system of claim 36, wherein the information received from the provisioning agent includes a certificate for the provisioning agent and a trust domain report for the trust domain manager.

39. The system of claim 38, further comprising the secure startup service module to:
receive a request from the I/O device to verify the trust domain report included in the certificate received from the provisioning agent;
verify the trust domain report via use of an integrity check of a message authentication code in the trust domain report; and
indicate via the information received from the secure startup service module after establishment of the second secure connection that the trust domain report has been verified to enable the I/O device to complete the attestation of the trust domain manager.

40. The system of claim 36, comprising:
the first communication link to operate according to at least one of a Peripheral Component Interconnect Express (PCIe) specification or a Compute Express Link (CXL) specification; and
the second communication link to operate according to a System Management Bus (SMBus) specification.
